(19) United States
(12) Patent Application Publication
(10) Pub. No.: US 2005/0198180 A1
(43) Pub. Date: Sep. 8, 2005

(54) Method and system for providing automatic email address book

(76) Inventors: Vidyesh Khanolkar, New Delhi (IN); Gopal Pradhan, Mumbai (IN); Vinod Paniker, Mumbai (IN)

Correspondence Address: HOGAN & HARTSON LLP, ONE TABOR CENTER, SUITE 1500, 1200 SEVENTEENTH ST, DENVER, CO, 80202, US

(21) Appl. No.: 11/064,061

(22) Filed: Feb. 23, 2005

(30) Foreign Application Priority Data
Feb. 23, 2004 (IN) 271/DEL/2004

(51) Int. Cl. G06F 15/16

(52) U.S. Cl. 709/206

(57) ABSTRACT

An address book is created automatically when a user sends, replies or forwards mail. The email addresses and mobile numbers to which a mail or message has been sent are stored in the address book. This information is presented to the user the next time he tries to compose another email or SMS and types the first character of an email address. The Address Prompter technology of the present invention enables an internet based application to build memory and intelligence into it, by remembering not only the numbers but also the contacts from which the user has received messages.

### FIELD OF THE INVENTION

The present invention relates to communication through Internet and more specifically to the field of electronic mails. More particularly, te present invention relates to method and system for providing an automatic email address book In general it relates to communication through Internet and more specifically to the field of electronic mails.

### BACKGROUND OF THE INVENTION

One of the most popular ways to communicate through Internet is through electronic mail i.e. the exchange of electronic messages through computer networks. In many ways electronic mail is the most successful of the groupware tools, certainly in terms of volume—it is currently used by 75 million worldwide. Electronic mail is valued both in corporate and personal domains. Email is cheaper and faster than a letter, less intrusive than a phone call, less hassle than a FAX. Using email, differences in location and time zone are less of an obstacle to communication.

In order to use email one would need:
a. an internet connection,
b. an email account or address, and
c. a password.

Every person who uses email has his or her own unique email address. When writing a message, the sender may refer to their address book to check what the email address of the receiver is. They then write their message, including a return address and sometimes even a signature. Email addresses are of the form of name@place.xxx where @ is pronounced as “at” and “name” is the username provided by the user or the Internet service provider. The second part is the email domain. Some examples could be ibm.com, uspto.org etc.

One needs to type the email address in the “To” field. This field identifies the recipient of the email. If the address typed is wrong, the sender would receive a failure notice notifying that no such user exists. This may cause huge time delay and other losses in corporate sectors. Typing long and difficult email addresses take time and are error prone. To avoid this, users have to maintain an address book. Address books are online contact managers just like paper or desktop address book but with additional functionalities. Address books stores the name, email addresses and other details. When a user types the name of the person entered in the address book, the email address is entered, so a user does not need to type the whole address.

The disadvantage with the present address book is that there is no facility for automatic entry in address books. A user has to specifically follow a number of steps to make an entry in the address book. Further, there is no solution with respect to the typing which the user has to do. A user has to either type the address or the name, if he uses the address book. There is also no facility to save mobile numbers if a user sends messages to mobiles. Also scrolling through address books takes time if there are too many entries.

### SUMMARY OF THE INVENTION

It is an objective of the present invention to overcome the aforementioned drawback and provide an automatic email address book. It is an object of the present invention to automatically add those entries to the address book to which the user has sent an email or received an email from. It is further an object of the present invention to present a sorted email address list to the user. It is another object of the present invention to limit the addresses from which a user would select the address needed. It is still another object to store mobile numbers in the address book for sending messages.

To achieve the aforementioned objectives the invention provides an address prompter—an address book created automatically when a user sends, replies or forwards a mail. The email addresses and mobile numbers to which a mail or message has been sent are stored in the address book. This information is presented to the user the next time he tries to compose another email or SMS and types the first character of an email address. This list is further pruned as and when the user types further alphabets of the name/address. He is shown a sorted list of email addresses starting with the same character thereby obviating the need for the user to remember email addresses and mobile numbers of people he has communicated with. This information is presented to the user in a small window in sorted manner so that it makes it easy for the user to search for the information.

### BRIEF DESCRIPTION OF THE ACCOMPANYING DRAWINGS

FIG. 1 relates to a flow diagram illustrating how the present invention works.

FIG. 2 describes the system implementing the address prompter technique.

### DETAILED DESCRIPTION OF THE DRAWINGS

The basic utility of the present invention is where the client-server architecture is used. One user sitting on a client machine is connected to another user sitting on another client machine through a server. Any page or information needed by a user is downloaded from a server. The user sends a request for a page through a Uniform Resource Locater (URL). The URL identifies that the request will go to which web server. Each URL has a first part that indicates what protocol to use, and the second part that specifies the IP address or the domain name where the resource is located. Accordingly a web page request reaches a particular web server. Similarly an electronic mail (email) reaches a web server before reaching the recipient. The server then identifies the location of the recipient this also happens with the help of the email address, which identifies the user name and the domain.

E-mail has two parts: (a) the Header, and (b) the Body.

The header contains the email address typed by the user and the body contains the message of the mail. The email address identifies the domain name and accordingly reaches a web server. The web server has a parser for removing the address from the email. The location of the recipient is identified and the email is delivered. The address prompter technology used in the present invention takes care of the address, which was parsed.

Address Prompter (AP) technology enables an internet based application to build memory and intelligence into it, thereby providing a much better experience to the user of the application. AP technology remembers all the email addresses and mobile numbers to which a user has sent any communication in form of email or SMS through the internet. It also remembers the contacts from which the user has received messages. This information is presented to the user in a small window in sorted manner so that it makes it easy for the user to search for the information. The information in the window is constantly refreshed depending on the keys pressed by the user. Only that information is displayed in the window that matches the sequence of keys pressed by the user thus narrowing his search. Thus it allows the user to recall an entire email address by just typing few keys and results in time saving in form of minimal keystrokes to retrieve an email address or mobile number.

For example if the users automatic address book under the present system has the following email addresses stored:
akhil@cont.com
akshay@bill.com
akhilesh@hat.com
brian@jill.com
garima@fire.com
gary@tops.com

in such a scenario if the user types the alphabet ‘a’ in the To field, he would be shown all the email ids that start with the alphabet a i.e. akhil, akshay, and akhilesh. If he further types the alphabet ‘k’, all three would still remain as all of them begin with ‘ak’. However if he types ‘h’ next then akshay would not be displayed as the third alphabet in akshay is ‘s’ and not ‘h’. Similarly if the user types ‘gar’ as the first few alphabets, both garima and gary would be shown but on typing ‘i’, gary would be pruned out. This way the user keeps on narrowing his list depending upon what he types.

Similarly the technology would work for mobile numbers and first names etc.

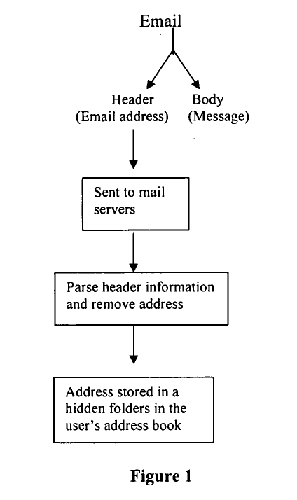

According to the present invention, as shown in the FIG. 1, the mail server parses the header information and removes the address from it. The address can be of any mail server eg. yahoo, rediff etc. A script running at the server end creates a hidden folder in the user's address book. The addresses are stored in the folder as a sorted list. When the user tries to send, reply or forward an email the next time, on typing just the first character of the email address, he is provided with the list of addresses stored in the hidden folder of the address book. As he continues to type the second character, the unmatched addresses keep disappearing, thus helping the user by making him select an address from the limited list. Accordingly a user does not need to explicitly maintain an address book. Of course if he so desires, the user can enter additional entries into his address book. They would also be stores in a sorted manner and shown the next time the user tries to send an email.

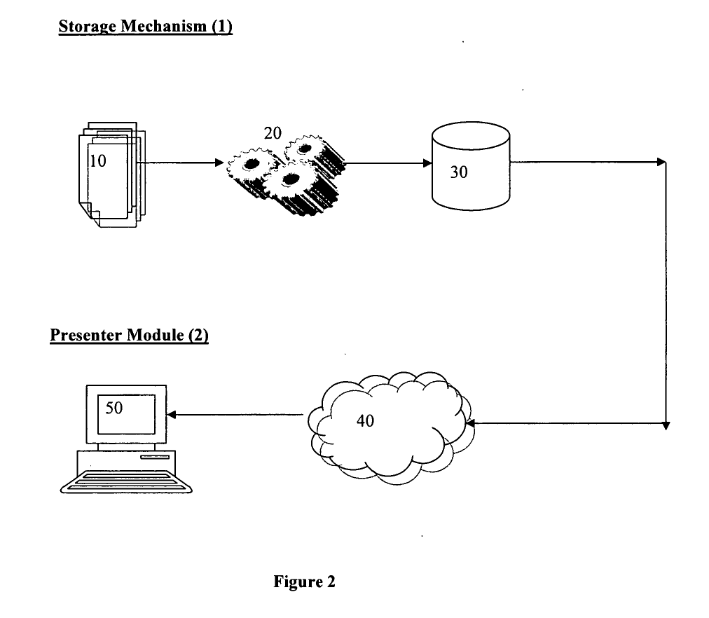

The heart of the technology lies in the storage mechanism (1) as illustrated in FIG. 2. It uses a database driven file system (30) to store all the email addresses and mobile numbers to which a user has sent any communication through email or SMS. Any email or SMS being sent by the user is parsed at the parser (20) by the AP technology system and the email or mobile number is extracted from the message that is being sent. This information is checked in the database file (30) for any duplicity and is stored in the file if the information doesn't exist. This database file can be stored at any place where the application resides. The information parsed is stored in the database in a sorted manner. In the preferred embodiment the invention uses the Berkley DB™ file system. Berkeley DB is an embedded database system that supports keyed access to data. The software is distributed in source code form, and developers can compile and link the source code into a single library for inclusion directly in their applications.

Developers may choose to store data in any of several different storage structures to satisfy the requirements of a particular application. In database terminology, these storage structures and the code that operates on them are called access methods.

Parsing means analyzing a text and producing structured data in a form that is useful for programs. It can be a list of strings, a set of classes instances, or just a boolean result: this depends on the needs and the parsing system one is using. An important aspect of parsing is the architecture that is used to process the text that you want to analyze. Parsing can be done by just reading a file or a stream line by line, and by looking for the occurrence(s) of a word, or a pattern. A parser is a program, or more likely a procedure within a program, which scans a sequence of input characters or input tokens and accumulates them in an input buffer or stack. It consists of three basic components: A set of syntax tables, a set of reduction procedures and a parsing engine. The parsing engine is the body of code that interprets the parsing table, invokes input functions, and calls the reduction procedures. A “reduction procedure” is a function you write which your parser executes.

It's now the task of the ‘Presenter’ module (2) of AP technology to present this information to the user in a window when the user tries to compose a new mail or a SMS. The user accesses the internet based application remotely over the internet (40) using any browser (50). The presenter module integrates itself seamlessly into the browser using JavaScript technology. The presenter module fetches all the information stored in the Berkeley DB file system over the Internet. It then presents this information to the user in a window drawn in the browser. This module also refreshes this information based on the keystrokes punched by the user. It matches the sequence of keys pressed by the user with the information it has stored and displays only that information that matches thus filtering other information.

The storage mechanism creates a folder in the address book, at the server, for each user logging in for the first time and stores the email addresses after parsing the messages. Thereafter, when the user logs in again later and presses the first key for entering an email address or a mobile number, he is presented with the email ids or numbers in the form of hyperlinks, starting with the letter or number entered by the user. The addresses presented to the user are sorted for the ease of the user. On clicking the fetched information, the address or number automatically reaches the space meant for the address of the recipient. The user can click on as many addresses as he desires.

The information about the email addresses and the mobile numbers are stored on a server at a remote site. The above described presenter module fetches the filtered information from the site and produces them in a window in the browser. The filtering and fetching is triggered when a user presses a key. Instantly the presenter module reads the keystroke, filters the data from the server and produces them before the user.

It will readily be appreciated by those skilled in the art that the present invention is not limited to the specific embodiments shown herein. Thus variations may be made within the scope and spirit of the accompanying claims without sacrificing the principal advantages of the invention.

1. A method for providing an automatic electronic mail address book at a server in a client server based communication network, said method comprising the steps of:
parsing an email to extract the email addresses or mobile numbers to which the user has sent or received some communication through said network;
storing the parsed email addresses in a address book folder;
showing a contact address list to the user containing the addresses fetched from said folder when the user is sending a new email; and
dynamically updating said address list as and when the user types the characters for the recipient's address.

2. The method as claimed in claim 1, wherein the email addresses are parsed from the headers of the emails sent by the user and stored in said folder in a sorted order.

3. The method as claimed in claim 1, wherein the user is presented with said contact address list instantly on typing the first character of recipient's address.

4. The method as claimed in claim 3, wherein said contact list is presented in a sorted order in a window in the browser.

5. The method as claimed in claim 4, wherein the addresses in the contact list are hyperlinks and automatically reach the space allotted for the recipients address when they are clicked.

6. The method as claimed in claim 5, wherein a user can click on more than one address.

7. The method as claimed in claim 1 wherein the network comprises internet and intranet.

8. A system for providing an automatic electronic mail address book at a server in a client server based communication network comprising:
a parsing engine for extracting the email addresses or mobile numbers to which a user has sent or received some communications;
a database system for storing the parsed addresses in a folder; and
a script executing at the server for presenting a contact address list to the user containing addresses from said folder and dynamically updating the same.

9. A method for providing an automatic electronic mail address book at a server in a client server based communication network substantially as herein described in the accompanying drawings.

10. A system for providing an automatic electronic mail address book at a server in a client server based communication network substantially as herein described in the accompanying drawings.
